(19) United States
(12) Patent Application Publication
(10) Pub. No.: US 2024/0165908 A1
(43) Pub. Date: May 23, 2024

(54) COMPOSITE STRUCTURE FOR A CROSSARM

(71) Applicant: RS Technologies Inc., Tilbury, Ontario (CA)

(72) Inventors: Shawn VAN HOEK-PATTERSON, Tilbury, Ontario (CA); Mingzong ZHANG, Tilbury, Ontario (CA); Joel TENNISON, Tilbury, Ontario (CA); Mark FORGET, Tilbury, Ontario (CA); Scott T. HOLMES, Tilbury, Ontario (CA)

(21) Appl. No.: 18/283,430

(22) PCT Filed: Mar. 3, 2022
(86) PCT No.: PCT/CA2022/050425

§ 371 Date: Sep. 21, 2023

Related U.S. Application Data
(60) Provisional application No. 63/164,475, filed on Mar. 22, 2021.

(51) Int. Cl. B32B 3/04; B29C 69/02; B29C 70/52; B29K 75/00; B29K 105/04; B29K 105/12; B29K 309/08; B29L 31/00; B32B 5/02; B32B 5/18; B32B 5/24

(52) U.S. Cl. CPC B32B 3/04; B29C 69/02; B32B 5/02; B32B 5/18; B32B 5/245; B29C 70/523; B29K 2075/00; B29K 2105/04; B29K 2105/046; B29K 2105/12; B29K 2309/08; B29K 2995/0007; B29K 2995/0016; B29K 2995/0063; B29L 2031/766; B32B 2260/021; B32B 2260/046; B32B 2262/101; B32B 2266/0278; B32B 2266/08; B32B 2307/3065; B32B 2307/54; B32B 2307/71; B32B 2307/72

(57) ABSTRACT

There is described a composite structure. The composite structure has an inner core comprising foam. The composite structure further includes an outer shell surrounding the inner core and comprising a mixture of fiber reinforcement, such as fiberglass, and a resin. The resin is resistant to ultraviolet radiation. The composite structure may be used in a crossarm or a brace of a utility pole.

### FIELD OF THE DISCLOSURE

The present disclosure relates to a composite structure suitable for a crossarm. The disclosure further relates to various devices, such as a crossarm or a brace member, comprising the composite structure.

### BACKGROUND TO THE DISCLOSURE

It is important that crossarms as used on utility poles be able to withstand the rigours of the environment in which they are found. Existing crossarms, however, suffer from one or more drawbacks that prevent them from benefiting from longer lifespans.

For example, wood crossarms are problematic for at least the following reasons: (1) they are susceptible to cracking, checking, rotting, insect infestation, and corrosion resulting in decay of the crossarm structure over time; (2) they are not an engineered product, and hence their performance cannot be relatively determined in the same manner as that of a product made of engineered materials (this is a concern both at the time of initial installation as well as throughout the life of the crossarm, whose performance progressively declines at a rate that is difficult to establish); and (3) they show a trend of decreasing mechanical properties owing, for example, to silvicultural processing.

Concrete crossarms are susceptible to cracking, spalling, corrosion, and deterioration due to erosion. Steel crossarms are conductive, will corrode over time unless preventative (and sometimes toxic) coatings are applied, and are subject to arcing, and may therefore readily facilitate pole top fires. The rot, decay, and deterioration leads to two very significant problems with such crossarms: (1) structural inadequacy during installation and over time, and premature structural failure; and (2) potential for arcing and tracking of electrical current with electrical failure, potentially transmitting leakage current causing a short circuit, and possibly resulting in pole top fires or even electrocution of innocent bystanders.

In order to address these drawbacks, composite crossarms have been on the market for more than 25 years, and, although they are an improvement over wood, steel, and concrete offerings, currently available composite crossarms have also been susceptible to the mechanisms of ultraviolet (UV) radiation-degradation, wear, and surface erosion which have led to numerous mechanical and electrical performance issues over time. Even with this history and experience, inferior composite structures that do not perform over the long term continue to be used to address issues with wood, concrete, and steel crossarms.

Most composite crossarm manufacturers claim performance for only 25-40 years of service. In service, the actual performance varies wildly, with some customers reporting fiberglass composite crossarms “blooming” with exposed glass fiber (also known as “fiberglass”) long before the 25-year service mark. While some see this blooming as only a cosmetic or handling issue, others see this breakdown on the composite surface as a real concern because of degraded structural and electrical performance. While this modified surface may have a cosmetically negative effect, it can also create a pathway for tracking of electrical current along the crossarm, leading to catastrophic failure if a short circuit were to occur or if substantial leakage current were transported along the crossarm into the pole structure.

### SUMMARY OF THE DISCLOSURE

According to a first aspect of the disclosure, there is provided a composite structure comprising: an inner core comprising foam; and an outer shell surrounding the inner core and comprising a mixture of fiber reinforcement and a resin, wherein the resin is resistant to ultraviolet (UV) radiation.

The fiber reinforcement may comprise fiberglass.

The fiber reinforcement may be impregnated by the resin.

The composite structure may be formed by a pultrusion process.

The resin may comprise an aliphatic polyurethane resin.

The aliphatic polyurethane resin may be a dicyclohexylmethane diisocyanate (HMDI)-terminated polyether prepolymer or an aliphatic isocyanate resin.

The aliphatic polyurethane resin may be an aliphatic isocyanate resin based on hexamethylene diisocyanate.

The mixture may extend at least partially between an exterior surface of the outer shell and an interior surface of the outer shell.

The mixture may extend from the exterior surface of the outer shell to the interior surface of the outer shell.

The resin may be resistant to accelerated exposure to 8,000 hours of UV radiation in accordance with ASTM G154.

The resin may extend at least partially between an exterior surface of the outer shell and an interior surface of the outer shell.

The resin may extend from the exterior surface of the outer shell to the interior surface of the outer shell.

The inner core may be integrally bonded to the outer shell.

The composite structure may be UV-resistant throughout the entire composite structure.

The composite structure may not comprise a UV-resistant coating provided on the outer shell, such as a secondary or in-line UV-resistant coating different to the UV-resistant resin.

The foam may comprise polyurethane.

The foam may be a closed-cell foam.

The foam may be a high-density foam.

A density of the foam may be at least about 5 pounds per cubic foot.

The density of the foam may be from about 10 to about 20 pounds per cubic foot.

The inner core may have a compression strength of at least 300 pounds per square inch.

The composite structure may be non-conductive.

The resin may be fire-resistant.

The composite structure may form an elongate member.

Endcaps may be secured to ends of the elongate member.

At least one of the endcaps may be UV-resistant.

The at least one of the endcaps may meet the UL-746 F1 rating.

At least one of the endcaps may comprise UV-resistant plastic.

At least one of the endcaps may comprise one or more retention features for securing the at least one of the endcaps to one of the ends of the elongate member.

The one or more retention features may be resiliently biased.

The elongate member may be rectangular.

At least one corner of a cross-section of the inner core may comprise a straight portion, wherein the cross-section is taken perpendicularly to a longitudinal axis defined by the elongate member.

At least one corner of a cross-section of the outer shell may be curved, wherein the cross-section is taken perpendicularly to a longitudinal axis defined by the elongate member.

According to a further aspect of the disclosure, there is provided a method of forming a composite structure, comprising: forming by pultrusion an outer shell comprising a mixture of fiber reinforcement and a resin, wherein the resin is resistant to ultraviolet (UV) radiation; and during the pultrusion of the outer shell, filling a cavity defined by the outer shell with a foam.

Filling the cavity may comprise injecting the foam into the cavity.

Forming by pultrusion the outer shell may comprise molding the fiber reinforcement into a preform of the outer shell.

Forming by pultrusion the outer shell may further comprise injecting the resin into the preform during the pultrusion.

Filling the cavity with the foam may comprise filling the cavity with the foam while the preform is at a temperature of from about 120 degrees C. to about 150 degrees C.

The cavity may be filled with the foam in-line with the pultrusion of the outer shell.

As a result of the cavity being filled with the foam during the pultrusion of the outer shell, the foam may be integrally bonded to the outer shell.

According to further aspects of the disclosure, there is provided a crossarm for a utility pole, and a brace for a utility pole, comprising any of the above-described composite structures.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a perspective view of a composite member according to an embodiment of the disclosure;

FIG. 2 is a cross-sectional view of the composite member of FIG. 1, according to an embodiment of the disclosure;

FIG. 3 is a magnified view of a corner of the cross-section of FIG. 2, according to an embodiment of the disclosure;

FIG. 4 is a side-on view of a crossarm, according to an embodiment of the disclosure;

FIG. 5 shows a utility pole with a crossarm and cross braces, according to an embodiment of the disclosure;

FIGS. 6A-6C are respectively, end-on, side-on, and cross-sectional views of an endcap, according to an embodiment of the disclosure;

FIGS. 7A-7C are respectively, end-on, side-on, and cross-sectional views of an endcap, according to an embodiment of the disclosure;

FIG. 8 is a perspective view of a crossarm with an endcap, according to an embodiment of the disclosure; and

FIG. 9 is a flow diagram of a method of forming a composite structure, according to an embodiment of the disclosure.

### DETAILED DESCRIPTION

The present disclosure seeks to provide an improved composite structure for a crossarm. While various embodiments of the disclosure are described below, the disclosure is not limited to these embodiments, and variations of these embodiments may well fall within the scope of the disclosure which is to be limited only by the appended claims.

Generally, according to embodiments of the disclosure, there are described embodiments of a composite structure that may be used, for example, to make a crossarm or a brace (such as a cross brace) for a utility pole. The composite structure comprises an inner, structural foam core, and an outer shell composite surrounding the inner core and comprising a mixture of fiber reinforcement, such as fiberglass, and a resin. The resin is resistant to ultraviolet (UV radiation) and may comprise an aliphatic polyurethane resin.

Existing composite crossarms are typically coated with a UV-resistant coating in order to provide protection from weathering and UV radiation. The UV coatings tend to be thin, typically between 1-3 mils in thickness, and are hence susceptible to peeling, cracking, crazing, and pin holing over time. Such coatings therefore generally only provide surface-level protection (i.e. short-term protection) to the crossarm and, once this outer coating is breached, the degradation of the crossarm occurs with progressively greater and greater amounts of exposed glass fiber and pathways for airborne contaminants, conductive particles, and moisture to penetrate within and permeate into the inner layers of the laminate.

By using an outer shell that comprises a mixture of fiberglass and a UV-resistant resin, integral UV-protection may be provided for the composite structure and may extend throughout the entire thickness of the outer shell. Such protection may enable a crossarm or other device incorporating the composite structure to benefit from improved resistance to moisture penetration, rot, decay, corrosion, erosion, etc. over time. Accordingly, such a crossarm or other device incorporating the composite structure may have a useful lifespan of about 80-100 years. One result of this is that, from an electrical service and system reliability standpoint, the crossarm does not become the “weak link” in the chain. For example, the expected life of a crossarm according to embodiments described herein is much closer to the expected life of the utility pole and other components on the utility pole. This may reduce the amount of planned inspection/maintenance that is required.

Other advantages of embodiments of the disclosure will become apparent in the following detailed description.

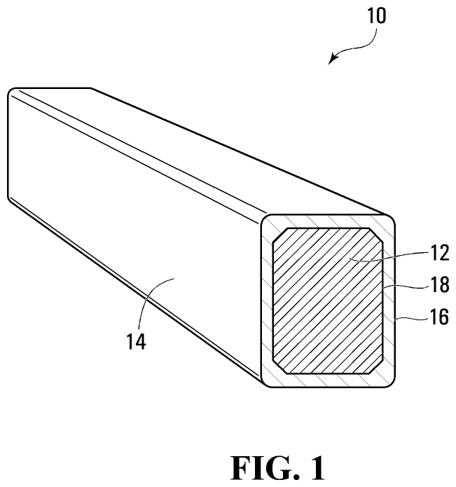

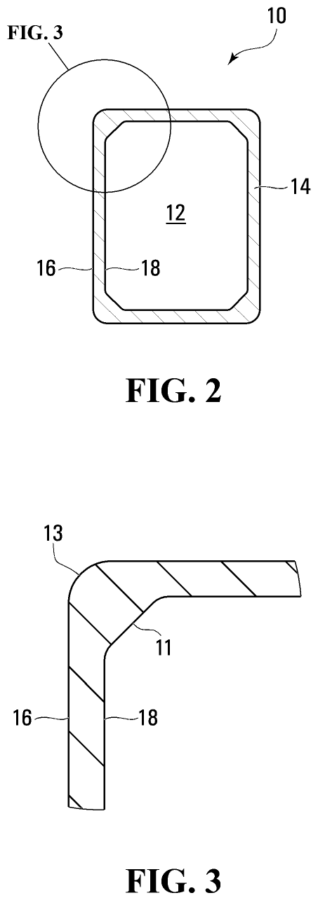

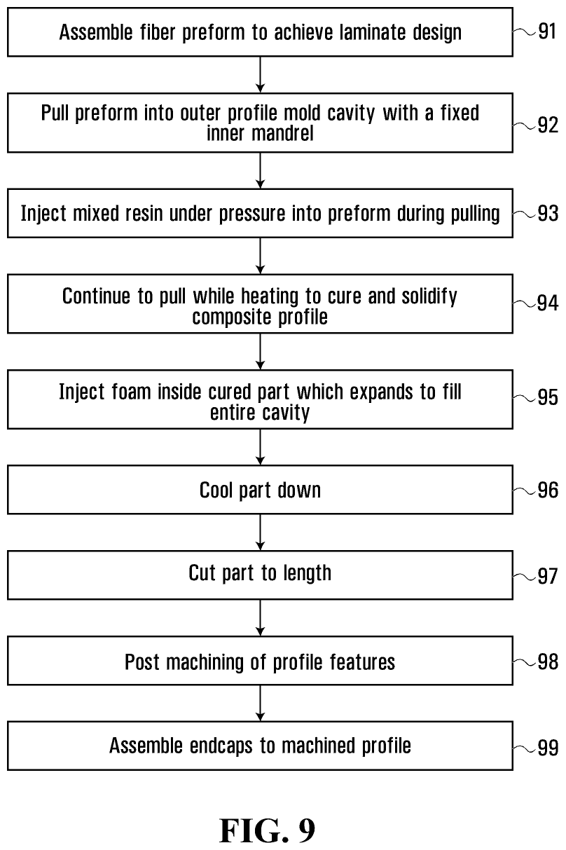

Turning to FIGS. 1 and 2, there are shown views of a beam-shaped, elongate, composite member 10 formed using a composite structure according to an embodiment of the disclosure. Composite member 10 is generally rectangular in shape, although composite member 10 may take any other suitable shape, and for example may have a triangular or a hexagonal cross-section. Composite member 10 is formed according to a pultrusion process described in further detail below in connection with FIG. 9, although according to some embodiments composite member 10 may be formed according to one or more other processes known to those of skill in the art. For example, composite member 10 may be formed according to the pultrusion process described in US Patent Publication No. US 2009/0023870, herein incorporated by reference in its entirety. According to some embodiments, instead of being formed according to solely a pultrusion process, composite member 10 may be formed by a combination of pultrusion and filament winding, or solely filament winding.

Composite member 10 comprises an inner foam core 12 comprising a structural foam that fills an inner cavity defined by an outer shell composite 14 (inner foam core 12 may be referred to throughout as inner core 12). In particular, inner core 12 is formed of a high-density, closed-cell, aromatic polyurethane foam, although according to some embodiments other types of foam may be used, such as expandable polystyrene foam, aliphatic polyurethane foam, or one or more epoxy-derivative foams. The foam provides both rigidity and stability to composite member 10, and also prevents moisture intrusion into the composite structure. The foam has a density of preferably at least 5 pounds per cubic foot, and more preferably between 10 and 20 pounds per cubic foot to ensure compression strength is sufficient for resisting crushing during application of through-bolts, and for resisting compressive forces associated with the application of through-bolts.

Surrounding inner core 12 is outer shell composite 14 comprising a mixture of fiberglass and a UV-resistant resin (outer shell composite 14 may be referred to throughout as outer shell 14). According to some embodiments, the resin is an aliphatic polyurethane resin, although other types of resins may be used. According to some embodiments, instead of fiberglass, other types of fiber reinforcement using other types of fibers may be used, such as basalt fibers or carbon fibers. According to some embodiments, the resin should withstand at least 8,000 hours of accelerated weathering in accordance with ASTM G154 (Standard Practice for Operating Fluorescent Ultraviolet (UV) Lamp Apparatus for Exposure of Nonmetallic Materials) without any significant degradation, such as blistering, cracks, checking, or flaking. The aliphatic polyurethane resin may be a dicyclohexylmethane diisocyanate (HMDI)-terminated polyether prepolymer or an aliphatic isocyanate resin based on hexamethylene diisocyanate. According to some embodiments, outer shell 14 has a thickness of between about 0.2 and about 1 inch.

When forming outer shell 14 according to the pultrusion process as described in further detail below, the fiberglass is impregnated by the resin. Integral UV protection may therefore be present on all or substantially all surfaces of composite member 10, including the inside edges of holes that have been drilled for attachments, etc. In particular, referring to FIG. 2, the UV-resistance provided by the resin extends generally from an exterior surface 16 of outer shell 14 to an interior surface 18 of outer shell 14. According to some embodiments, a concentration of the resin may be greater in certain areas of outer shell 14 than in other areas. For example, referring to FIG. 2, according to some embodiments the resin may extend only partway between exterior surface 16 and interior surface 18, such as for example up to 90% of the distance between exterior surface 16 and interior surface 18.

By virtue of the particular pultrusion process according to which composite member 10 is formed, inner core 12 is integrally bonded to outer shell 14. For example, inner core 12 may be chemically bonded to outer shell 14, mechanically bonded to outer shell 14, or a combination of chemically and mechanically bonded to outer shell 14. In particular, as described in further detail below, the central cavity formed within outer shell 14 during the pultrusion of outer shell 14 is filled with the foam, for example by injection, after outer shell 14 has cooled sufficiently for the preservation of laminate but while outer shell 14 is still at an elevated temperature, for example from about 120 to about 150 degrees Celsius, such as for example about 135 degrees Celsius. As a result, outer shell 14 comprising the composite of fiberglass and resin is structurally bonded to the expanding polyurethane foam forming inner core 12.

Advantageously, by providing the foam during the pultrusion process, the need for any secondary operations to provide a structural foam material that is integrally bonded to inner surface 18 of outer shell 14 may be avoided. As a result, composite member 10 may provide sufficient compression strength (e.g. up to about 300 psi) and stiffness so as to eliminate the need for secondary reinforcements or bushings prior to hardware installations, and may support typical assembly and installation loads without being crushed. For example, according to some embodiments, for a foam with a density of 12 pounds per cubic foot, the compressive strength was measured to be 375 psi at 5% deflection, and 390 psi at 10% deflection. According to some embodiments, for a foam with a density of 15 pounds per cubic foot, the compressive strength was measured to be 565 psi at 5% deflection and 615 psi at 10% deflection. According to some embodiments, for a foam with a density of 25 pounds per cubic foot, the compressive strength was measured to be 1,235 psi at 5% deflection and 1,490 at 10% deflection. Furthermore, composite member 10 may have improved resistance to cracking and premature failure of outer shell 14 due to impact or dynamic shock loads. Still further, the structural foam may act as an additional energy-absorption and energy-damping mechanism.

Further still, by providing outer shell 14 that is integrally bonded to inner core 12, composite member 10 is capable of being drilled in the field. This may provide flexibility if standard framing holes are not provided or if modification in the field is required. Many typical crossarms require special procedures for drilling in the field, including the addition of inserts required for meeting compressive loads, bushings, or adhesive sealers. The addition of inserts, as well as the need for secondary processes in the factory, is typical practice as inserts enable local reinforcement to be provided to the crossarm. Also typical is backfilling with foam any open areas inside the crossarm prior to completion. Such procedures are difficult for utility companies to follow in the field, and therefore a product that cannot be field drilled is less desirable. The addition of secondary bushings and/or inserts applied in the field is also cumbersome to implement for utility companies, is less desirable, and may lead to installation errors that could result in structural damage upon installation if omitted or if installation is improper. Furthermore, inserts add weight and cost to crossarms, and in some instances limit the ability for drilling in the field which is sometimes necessary.

The bond formed between inner core 12 and outer shell 14 may also act as a barrier to moisture and insects. The foam interiors of existing crossarms are typically added using a secondary process, such that the foam may not adhere well to the outer shell. Such foam interiors may be more susceptible to shrinkage and distortion over time with changing environmental conditions, and, due to the lack of a connective bond with the composite wall, may leave gaps for moisture and insects to enter and occupy the available open space within the crossarm.

Turning to FIG. 3, there is shown a magnified view of a corner of a cross-section of composite member 10. As can be seen, the corners of the cross-section of inner core 12 comprise straight portions 11, while the corners of the cross-section of outer shell 14 are curved without straight portions. Thus, the curvature of the corners of outer shell 14 may be smooth and constant, whereas the curvature of the corners of inner core 12 is interrupted by a flat chamfer area which allows for the thickness of outer shell 14 to be increased in the corners of composite member 10. This feature also allows for greater unidirectional roving to be locally inserted at each corner while maintaining a uniform, inner laminate reinforcement structure of biaxial and continuous filament mats.

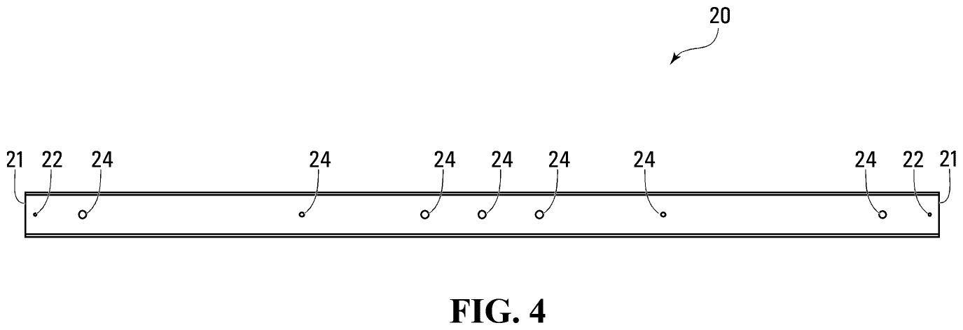

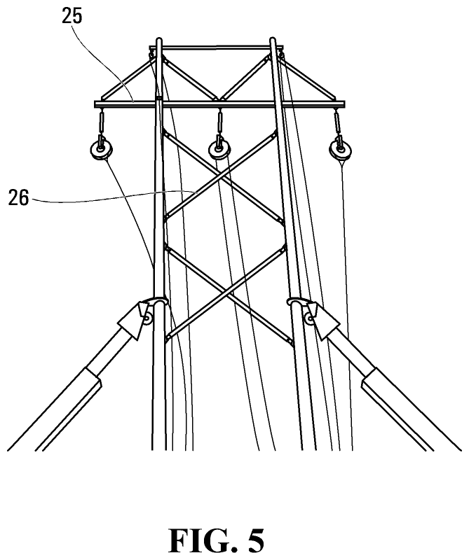

Turning to FIG. 4, there is shown a crossarm 20 formed using a composite structure as described herein. Crossarm 20 is a structural load-bearing member that may attach to a metallic centre-mount bracket which is then attached to a utility pole or the like. An example of a crossarm 25 secured to a utility pole is shown in FIG. 5. A function of crossarm 25 is to maintain conductor spacing between phases and ground or neutral lines by fixing insulators through crossarm 25 at predefined locations. The insulators are attached to crossarm 25 using a mounting stud which may vary in design and type but is securely clamped or bolted to crossarm 25. Also shown in FIG. 5 are cross-braces 26 that may also incorporate the composite structure defined herein.

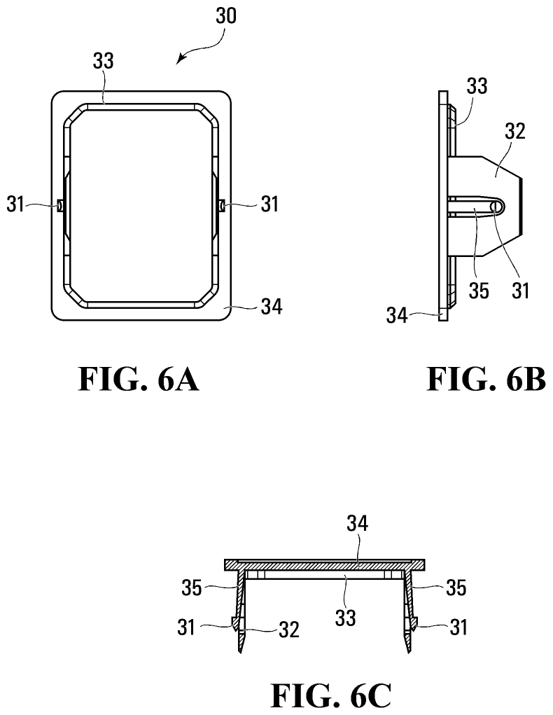

As can be seen in FIG. 4, crossarm 20 includes indexed retention features 22 (such as holes, slits, or notches) formed at ends of crossarm 20. Retention features 22 are apertures drilled through opposing faces of crossarm 20, indexed from end faces 21 of crossarm 20, and for engaging with corresponding retention buttons 31 on impact-resistant endcaps 30 (described in more detail in connection with FIGS. 6A-6C). As described in further detail below, retention buttons 31 are activated by spring levers 35 such that retention buttons 31 are resiliently biased toward retention features 22 when endcaps 30 are flush with end faces 21 of crossarm 20. When endcaps 30 are locked in place by retention buttons 31 engaging with retention features 22, a tight fit of endcaps to end faces 21 of crossarm 20 is ensured, thereby sealing off potential moisture and insect intrusion inside crossarm 20.

Crossarm 20 further includes mounting bolt through-holes 24 drilled through outer shell 14 and inner core 12 to enable crossarm 20 to be bolted to a mounting bracket (not shown) located centrally relative to crossarm 20, for subsequent attachment to a utility pole or the like. The structural closed-cell foam forming inner core 12 may have a minimum density sufficient to avoid crushing with bolt torque loading of up to about 75 ft.-lbs.

Turning to FIGS. 6A-6C, there are shown different views of a self-locking endcap 30 for sealing end faces 21 of crossarm 20. As described above, impact-resistant endcaps 30 attaches to end faces 21 of crossarm 20 for protecting exposed inner core 12 from the elements and potential impact during handling, installation, and while in service. Furthermore, as described above and below, endcap 30 may be secured to crossarm 20 without the need for fasteners or adhesives that might fail. Endcap 30 may also be UV-resistant, and for example may be made of a material comprising one or more UV-stable polymers, such as Lexan Copolymer SLX 2271, Lexan 143R, Geloy Resin XP4034, or Makrolon 2607. By providing the affixing means described above and below for securing endcaps 30 to end faces 21 of crossarm 20, endcaps 30 are less likely to fall off in the field which could otherwise directly expose the foam of inner core 12 to the environment and lead to premature erosion and crossarm failure.

Endcap 30 comprises a generally rectangular endplate 34 with a lip seal 33 extending therefrom. Endcap 30 further comprises a pair of retention tabs 32 and spring levers 35 extending from endplate 34. Retention tabs 32 are integrally moulded with endplate 34 such that the insertion force on endplate 34 can be transmitted to retention tabs 32 during movement of retention tabs 32 along the inner walls of the profile of composite member 10. Spring levers 35 are moulded into retention tabs 32 and attach to a root of retention tabs 32. The moulded plastic material forming spring levers 35 has sufficient flexibility to enable spring levers 35 to bend inward when endcap 30 is inserted and retention buttons 31 are depressed by the inner walls of the profile of composite member 10. Retention buttons 31 are located at ends of spring levers 35 and extend away from a centre of endplate 34.

During insertion, retention buttons 31 serve to actuate spring levers 35 and push spring levers 35 back to preload spring levers 35. Once retention buttons 31 reach indexed retention features 22 on each side of crossarm 20, the spring force is released as spring levers 35 actuate to bias retention buttons 31 into retention features 22. Once retention buttons 31 are locked into retention features 22, spring levers 35 retain retention buttons 31 in retention features 22 and endcap 30 is locked into place

In order to prepare composite member 10 for receiving endplates 34, a portion of the foam is cut away in the area where retention tabs 32 will occupy when installed. Retention features 22 are machined into the inner walls of the profile of composite member 10 relative to the end faces of composite member 10. This approach avoids any pathway for moisture intrusion that a drilled hole may present. Endcaps 34 are then aligned with the end faces of composite member 10. Endcaps 34 are then pushed into the composite member 10 until retention buttons 31 click into the machined retention feature 22. Lip seal 33 is designed to follow the inner profile of the crossarm composite surface. Lip seal 33 is chamfered to allow easier insertion into the mating foam materials and help with seating endcap 30 into the foam material and forcing lip seal 33 against the inner wall of the composite profile. Once endcap 30 is inserted into crossarm 20 and locked into place, lip seal 33 is fully engaged against the inner wall surface of the composite profile due to a close tolerance match. This tight fit ensures that endcap 30 protects the foam from exposure to the elements once endcap 30 is locked in place.

According to embodiments of the disclosure, endcaps 30 are formed using non-conductive materials, such as plastic. Eliminating metallic components from endcaps 30 may avoid rust or corrosion that could otherwise lead to endcap 30 backing out or loosening over time.

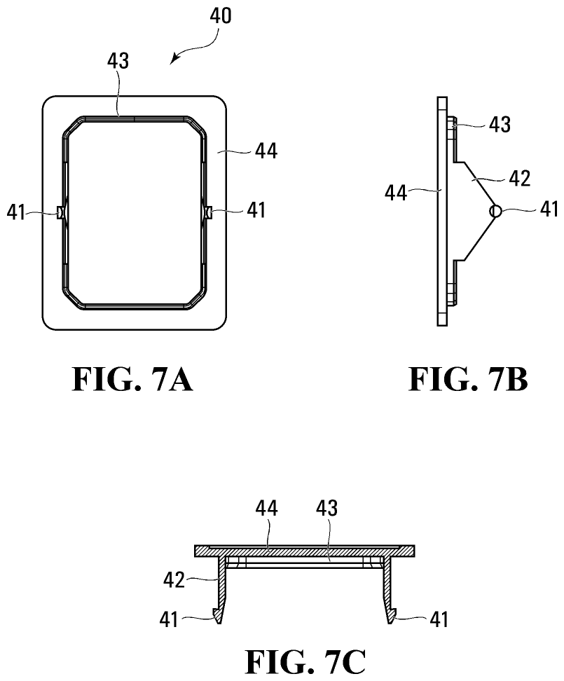

FIGS. 7A-7C shows views of an alternative endcap 40, with like features labelled using like reference numbers. In the embodiment of FIGS. 7A-7C, there is no separate spring lever, and all of retention tab 42 acts as a spring lever.

Endplates 34, 44 are generally rectangular for conforming to a profile of crossarm 20. However, according to some embodiments, endplates 34, 44 may have non-rectangular shapes.

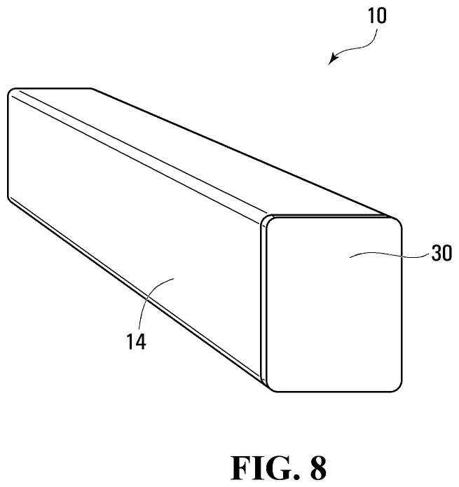

FIG. 8 shows an example of crossarm 10 with endcap 30 provided at an end thereof, according to an embodiment of the disclosure.

Turning to FIG. 9, there is shown a flow diagram showing a method of forming by pultrusion a composite structure, according to embodiments of the disclosure.

At block 91, a fiber preform is assembled to achieve the desired laminate design. At block 92, the fiber preform is pulled into an outer profile mold cavity with a fixed inner mandrel. At block 93, while pulling the preform, resin is injected under pressure into the fiber preform from the outer profile mold and fixed inner mandrel. At block 94, while still pulling the preform, the fiber and resin mixture is heated to cure and solidify the mixture into the final profile shape. At block 95, while the mixture is still hot, foam is injected at the end of the inner mandrel while inside the cavity formed by the cured mixture. The foam expands to fill the entire cavity, ensuring the desired foam density is reached. At block 96, after the foaming operation, the composite structure continues to cool down. At block 97, the composite structure, which is now a cured composite structure filled entirely with structural foam integrally bonded to the outer shell, approaches room temperature and is cut to a desired length. At block 98, retention features 22 are machined into the inside of the composite structure, accurately indexed from the cut ends. At block 99, self-locking endcaps 34 are inserted into the ends of the composite structure, where retention buttons 31 lock into place with retention features 22, and endcaps 34 seal the end of the composite structure without the use of any secondary fasteners or adhesive.

By virtue of the materials used for outer shell 14, inner core 12, and endcaps 30, crossarm 20 may be inherently non-conductive, and may act as a dielectric material up to high breakdown voltages. Furthermore, the use of integral structural foam bonded to inner wall 18 of outer shell 14 from in-line processing during the pultrusion process may assist in displacing moisture from the inside of crossarm 20 over its normal lifetime.

In addition, crossarm 20 may also be fire-resistant due to the resin used in outer shell 14, which based on test results is inherently a self-extinguishing material. This may assist in protecting crossarm 20 in the event of wildfires with flame front heights that reach or exceed the top of the pole (dependent of environmental conditions such as fuel type, fuel amount, applicable winds, etc.), pole top fires from electrical arcing, as well as conductor and transformer interfaces with high voltages within the pole top area.

In addition to being used for crossarms, the composite structure described herein may be used for heavier duty and transmission applications as well. For example, the composite structure could be used in alternative crossbrace applications, such as the “X” bracing between two poles that form an H-frame structure, or the “V” braces that support the main crossarm of an H-frame structure. Still further, the composite structure may be applied to other structures in electric power distribution and transmission, including strut braces used in distribution alley crossarm supports, transmission tower bracing of compound structures, and transformer supports.

It is estimated that a crossarm made using the composite structure described herein may have a lifespan of between 80 and 100 years, without requiring any maintenance.

Developing the resin formulation must balance the need for structural performance while also achieving the correct viscosity for injection into the die, the correct viscosity for wetting out the fiberglass at high volume fraction, and the correct reactivity for curing within the die stages at the correct temperature to match the run rate. According to some embodiments, polyol blends have viscosities in the range of 500-2,000 centipoise, preferably in the range of 750-1,350 centipoise at room temperature. According to some embodiments, aliphatic isocyanate has a viscosity in the range of 150-1,500 centipoise, preferable in the range of less than 500 centipoise at room temperature.

According to some embodiments of the disclosure, the foam may fill the cavity defined by outer shell 14 after the pultrusion process, or outer shell 14 and inner core 12 may be formed using alternative manufacturing methods. In other words, manufacturing of the composite structure described herein is not limited to pultrusion.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A composite structure comprising:
an inner core comprising foam; and
an outer shell surrounding the inner core and comprising a mixture of fiber reinforcement and a resin,
wherein the resin is resistant to ultraviolet (UV) radiation.

2. The composite structure of claim 1, wherein the fiber reinforcement comprises fiberglass.

3. The composite structure of claim 1 or 2, wherein the fiber reinforcement is impregnated by the resin.

4. The composite structure of any one of claims 1-3, wherein the composite structure is formed by a pultrusion process.

5. The composite structure of any one of claims 1-4, wherein the resin comprises an aliphatic polyurethane resin.

6. The composite structure of claim 5, wherein the aliphatic polyurethane resin is a dicyclohexylmethane diisocyanate (HMDI)-terminated polyether prepolymer or an aliphatic isocyanate resin.

7. The composite structure of claim 6, wherein the aliphatic polyurethane resin is an aliphatic isocyanate resin based on hexamethylene diisocyanate.

8. The composite structure of any one of claims 1-7, wherein the mixture extends at least partially between an exterior surface of the outer shell and an interior surface of the outer shell.

9. The composite structure of claim 8, wherein the mixture extends from the exterior surface of the outer shell to the interior surface of the outer shell.

10. The composite structure of any one of claims 1-9, wherein the resin is resistant to accelerated exposure to 8,000 hours of UV radiation in accordance with ASTM G154.

11. The composite structure of any one of claims 1-10, wherein the resin extends at least partially between an exterior surface of the outer shell and an interior surface of the outer shell.

12. The composite structure of claim 11, wherein the resin extends from the exterior surface of the outer shell to the interior surface of the outer shell.

13. The composite structure of any one of claims 1-12, wherein the inner core is integrally bonded to the outer shell.

14. The composite structure of any one of claims 1-13, wherein the composite structure is UV-resistant throughout the entire composite structure.

15. The composite structure of any one of claims 1-14, wherein the composite structure does not comprise a UV-resistant coating provided on the outer shell.

16. The composite structure of any one of claims 1-15, wherein the foam comprises polyurethane.

17. The composite structure of any one of claims 1-16, wherein the foam is a closed-cell foam.

18. The composite structure of any one of claims 1-17, wherein the foam is a high-density foam.

19. The composite structure of any one of claims 1-18, wherein a density of the foam is at least about 5 pounds per cubic foot.

20. The composite structure of claim 19, wherein the density of the foam is from about 10 to about 20 pounds per cubic foot.

21. The composite structure of any one of claims 1-20, wherein the inner core has a compression strength of at least 300 pounds per square inch.

22. The composite structure of any one of claims 1-21, wherein the composite structure is non-conductive.

23. The composite structure of any one of claims 1-22, wherein the resin is fire-resistant.

24. The composite structure of any one of claims 1-23, wherein the composite structure forms an elongate member.

25. The composite structure of claim 24, wherein endcaps are secured to ends of the elongate member.

26. The composite structure of claim 25, wherein at least one of the endcaps is UV-resistant.

27. The composite structure of claim 26, wherein the at least one of the endcaps meets the UL-746 F1 rating.

28. The composite structure of any one of claims 24-27, wherein at least one of the endcaps comprises UV-resistant plastic.

29. The composite structure of any one of claims 24-28, wherein at least one of the endcaps comprises one or more retention features for securing the at least one of the endcaps to one of the ends of the elongate member.

30. The composite structure of claim 29, wherein the one or more retention features are resiliently biased.

31. The composite structure of any one of claims 24-30, wherein the elongate member is rectangular.

32. The composite structure of claim 31, wherein at least one corner of a cross-section of the inner core comprises a straight portion, wherein the cross-section is taken perpendicularly to a longitudinal axis defined by the elongate member.

33. The composite structure of claim 31 or 32, wherein at least one corner of a cross-section of the outer shell is curved, wherein the cross-section is taken perpendicularly to a longitudinal axis defined by the elongate member.

34. A method of forming a composite structure, comprising:
forming by pultrusion an outer shell comprising a mixture of fiber reinforcement and a resin, wherein the resin is resistant to ultraviolet (UV) radiation; and
during the pultrusion of the outer shell, filling a cavity defined by the outer shell with a foam.

35. The method of claim 34, wherein filling the cavity comprises injecting the foam into the cavity.

36. The method of claim 34 or 35, wherein forming by pultrusion the outer shell comprises molding the fiber reinforcement into a preform of the outer shell.

37. The method of claim 36, wherein forming by pultrusion the outer shell further comprises injecting the resin into the preform during the pultrusion.

38. The method of claim 36 or 37, wherein filling the cavity with the foam comprises filling the cavity with the foam while the preform is at a temperature of from about 120 degrees C. to about 150 degrees C.

39. The method of any one of claims 34-38, wherein the cavity is filled with the foam in-line with the pultrusion of the outer shell.

40. The method of any one of claims 34-39, wherein, as a result of the cavity being filled with the foam during the pultrusion of the outer shell, the foam is integrally bonded to the outer shell.

41. A crossarm for a utility pole, comprising the composite structure of any one of claims 1-33.

42. A brace for a utility pole, comprising the composite structure of any one of claims 1-33.
